(19) United States
(12) Patent Application Publication
(10) Pub. No.: US 2026/0202720 A1
(43) Pub. Date: Jul. 16, 2026

(54) TRAIL CAMERA POSITIONING WEDGE

(71) Applicant: DEWAYNE FLOYD GILLEY, KINGSTON, MI (US)

(72) Inventor: DEWAYNE FLOYD GILLEY, KINGSTON, MI (US)

(21) Appl. No.: 19/018,049

(22) Filed: Jan. 13, 2025

(51) Int. Cl. G03B 17/56; A01M 31/00; F16B 2/08; F16M 13/02

(52) U.S. Cl. CPC G03B 17/561; A01M 31/002; F16B 2/08; F16M 13/022

(57) ABSTRACT

A one-piece wedge for positioning a trail or game camera at varying angles when mounted to a fixed pole, tree, or other structure. The wedge consists of a molded, semiflexible material with the underside being of a flat base and the upper side or face, consisting of a series of steps of increasing height and a void or opening in the center of the face, extending through the body to facilitate it being carried on the camera's mounting strap for storage. The device is placed behind the camera, with the camera body resting on one of the various steps to create the desired angle of the camera body, to properly aim the sensor and lens at a predetermined point.

### BACKGROUND

The embodiments herein relate to trail or game camera accessories, and more particularly to an accessory used to position the camera body at varying angles when mounted to a tree pole, post, or other similar object.

Trail or game cameras are typically mounted on trees or posts and are typically held in place by a mounting strap attached to the camera. The angle of the camera body, and thus the angle of the camera lens and sensors, are dependent on the angle of the object the camera is mounted to. To achieve the appropriate angle, the camera body position must be altered or adjusted using some form of accessory.

The currently available accessories commonly used are typically constructed in a manner which requires additional straps, screws, posts, or other hardware such as arms or locking levers, used to attach the accessory to the camera as well as adjust its position and angle of the lens and sensors.

The currently available accessories are typically constructed of a combination of rigid plastic, metal, or other hard materials as well as moving parts that create excess noise, as well as multiple failure points and areas subject to damage from extreme weather conditions.

Therefore, what is needed is a simplified, one-piece device to allow for the position of the camera angle, without requiring additional straps or mechanical parts as well as preventing mechanical failures of the positioning device, reducing in noise and eliminating failures due to weather conditions.

### SPECIFICATION

Some embodiments of the present disclosure include a one-piece, solid construction, trail or game camera accessory used to position the camera body at the desired angle of the user. The device is of a one-piece wedge-shaped construction with a series of steps of increasing height on the face and a flat base on the opposing side. The device has on opening in the center extending through the body from the face to the opposing side allowing the device to be stored on the camera's mounting strap when not in use. The increasing height of the steps on the face of the device allow the camera body to be positioned at various degrees of angle.

### BRIEF DESCRIPTION OF THE FIGURES

The detailed description of some embodiments of the invention is made below with reference to the accompanying figures where in like numerals represent corresponding parts of the figures.

FIG. 1 is a perspective view of the top or face and one side of the present disclosure.

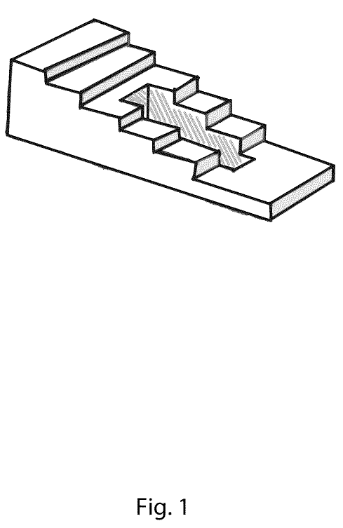

FIG. 2 is a perspective view of the top or face of the present disclosure.

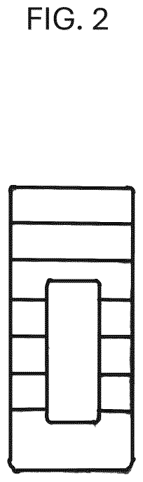

FIG. 3 is a perspective view of the invention 5 as it would be mounted in place behind a trail or game camera 6 between the camera body, showing the camera mounting strap 7 and attached to a tree or post 8.

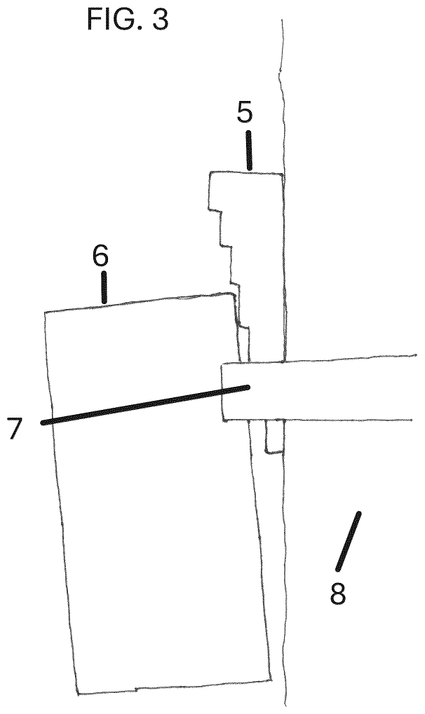

FIG. 4 is a perspective view of the invention 5 installed in the intended position between the camera body 6, held in place by the tension of the camera mounting strap 7 against the object the camera is mounted to 8 as seen from above.

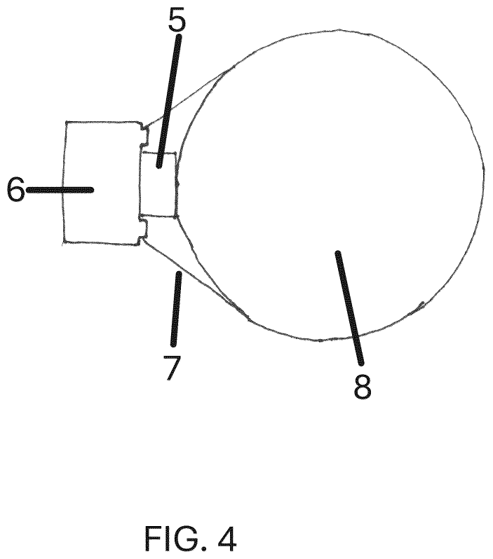

What is claimed is:

1. An externally mounted one-piece device used to position and/or alter the angle of a trail or game camera when it is mounted to an object by placing the device at varying heights between the camera body and the object it is mounted to, using one of the various steps to create the desired angle. The positioning steps are in ascending height from the tip of the device to the end of the device and can be used to increase or decrease the angle by carrying the position of the device between the camera body and the object it is mounted to. The opening or void in the body of the device permits the device to be stored and or carried on the camera's mounting strap.
